(19) United States
(12) Patent Application Publication
(10) Pub. No.: US 2013/0221859 A1
(43) Pub. Date: Aug. 29, 2013

(54) Lighting Device Having Phototransistor with On/Off Control Circuitry

(71) Applicant: Eveready Battery Company, Inc., (US)

(72) Inventor: Joseph Pavelchak, Lakewood, OH (US)

(73) Assignee: EVEREADY BATTERY COMPANY, INC., St. Louis, MO (US)

(21) Appl. No.: 13/772,602

(22) Filed: Feb. 21, 2013

Related U.S. Application Data
(60) Provisional application No. 61/602,628, filed on Feb. 24, 2012.

(51) Int. Cl. F21V 23/04

(52) U.S. Cl. CPC F21V 23/0464
USPC 315/159

(57) ABSTRACT

A lighting device, such as nightlight or path light is provided. The lighting device includes a power supply input, a light source, and a phototransistor for sensing ambient light. The lighting device also includes control circuitry for turning the light source on and off based on the sensed ambient light. The control circuitry includes a first resistor in series with the phototransistor and a second resistor in parallel with the phototransistor. The first resistor sets an illumination limit to turn the light source on and off and the second resistor introduces hysteresis such that the light source is turned on and off at different illumination limits. A path light may further include a motion sensor for sensing motion of an object and turns the light source on when both motion is detected and the sensed light is below an illumination level.

### CROSS REFERENCE

This application claims the benefit of U.S. Provisional Application No. 61/602,628, filed on Feb. 24, 2012.

### FIELD OF THE INVENTION

The present invention generally relates to lighting devices, and more particularly relates to a lighting device, such as an automatic nightlight employing a phototransistor to sense light and automatically turn the lighting device on and off.

### BACKGROUND OF THE INVENTION

Lighting devices such as automatic nightlights and path lights employ an on/off light detection sensor and control circuitry to turn the lighting device on in the dark and to turn the lighting device off when sufficient ambient light exists. Nightlights and path lights are commonly employed for household lighting to automatically turn on to provide light only in times of darkness. The on/off sensor typically is a phototransistor for sensing ambient light illumination levels. The application of a phototransistor into a nightlight or other lighting device may be difficult to apply in electronic circuitry with a lighting product which must be adjusted for the illumination level needed to turn the light on and off properly for the consumer. In some conventional lighting devices, the lighting output may flicker, particularly during changes in the sensed ambient light level. Accordingly, it would be desirable to provide for a lighting product employing a phototransistor that automatically turns the light on and off and reduces or eliminates light flicker.

### SUMMARY OF THE INVENTION

According to one aspect of the present invention, a lighting device is provided. The lighting device includes a power supply input, a light source and a phototransistor for sensing ambient light. The lighting device further includes control circuitry for turning the light source on and off based on the sensed ambient light. The control circuitry includes a first resistor in series with the phototransistor and a second resistor in parallel with the phototransistor. The first resistor sets an illumination limit to turn the light source on and off. The second resistor introduces hysteresis such that the light source is turned on and off at different illumination limits.

According to another aspect of the present invention, a nightlight is provided. The nightlight includes a power supply input, a light source and a phototransistor for sensing ambient light. The nightlight also includes control circuitry for turning the light source on and off based on the sensed ambient light. The control circuitry includes a first resistor in series with the phototransistor and a second resistor in parallel with the phototransistor. The first resistor sets an illumination limit to the turn the light source on and off. The second resistor introduces hysteresis such that the light source is turned on and off at different illumination limits.

According to a further aspect of the present invention, a path light is provided. The path light includes a power supply input, a light source and a phototransistor for sensing ambient light. The path light also includes a motion sensor for sensing motion of an object. The path light further includes control circuitry for turning the light source on and off based on the sensed ambient light and the sensed motion. The control circuitry includes a first resistor in series with the phototransistor and a second resistor in parallel with the phototransistor. The first resistor sets an illumination limit to turn the light source on and off. The second resistor introduces hysteresis such that the light source is turned on and off at different illumination limits. The lighting source is turned on when both motion is detected and the sensed ambient light is below the illumination level.

These and other advantages of the invention will be further understood and appreciated by those skilled in the art by reference to the following written specification, claims, and appended drawings.

### BRIEF DESCRIPTION OF THE DRAWINGS

In the drawings:

FIG. 1 is a perspective view of an automatic nightlight employing a light sensing phototransistor and control circuitry, according to one embodiment;

FIG. 2 is a circuit diagram illustrating the power supply circuit and control circuitry for the nightlight of FIG. 1;

FIG. 3 is a graph illustrating on/off control of the nightlight based on sensed ambient light with the control circuitry shown in FIG. 2;

FIG. 4 is a perspective view of a path light employing a light sensing phototransistor and control circuitry, according to another embodiment; and

FIG. 5 is a circuit diagram illustrating the power supply, motion sensing circuitry and control circuitry for the path light of FIG. 4.

### DETAILED DESCRIPTION OF THE PREFERRED EMBODIMENTS

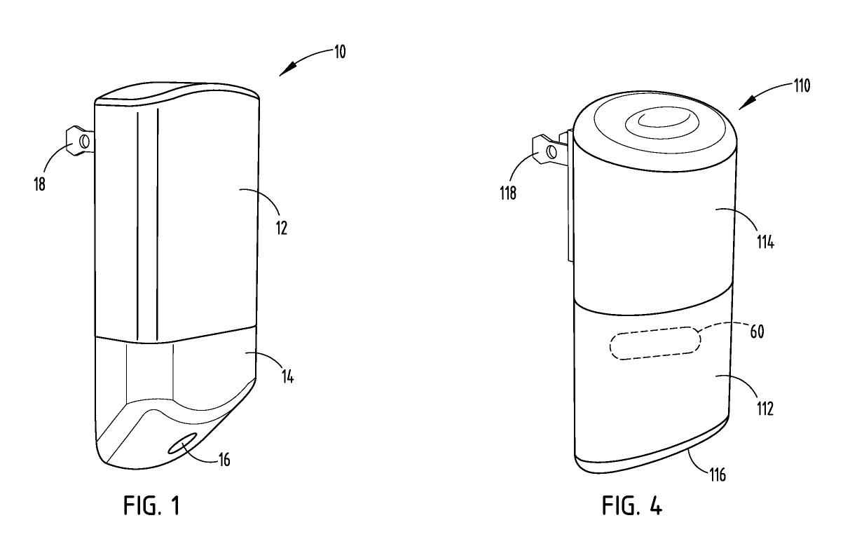

Referring now to FIG. 1, a lighting device 10 in the form of a nightlight is generally illustrated, according to one embodiment. The nightlight 10 generally includes a housing 12, a light illumination portion 14, an ambient light detection sensor 16 and an AC power connector 18 which serves as a power supply input. The housing 12 defines a volume that contains power control circuitry and light control circuitry. The light output portion 14 includes a light source, such as a light emitting diode (LED). It should be appreciated that one or more light sources may be employed to provide a light illumination output. The light detector 16 includes a phototransistor for sensing ambient light. The phototransistor may be connected as part of the control circuitry for controlling the light source to turn the light source on and off based on the sensed ambient light.

The lighting device 10 has a power supply input, shown including an alternating current (AC) connector 18. The AC connector 18 receives AC electric power from a conventional wall outlet. It should be appreciated that other power supply inputs may be employed. It should further be appreciated that a direct current (DC) power supply, such as a battery supply, may be employed to power the light source and other components of the lighting device 10.

The lighting device 10 employs control circuitry for turning the light source on and off based on the sensed ambient light detected by the phototransistor. The control circuitry includes a first resistor in series with the phototransistor and a second resistor in parallel with the phototransistor. The first resistor sets an illumination limit for controlling when the light source is turned on and off. The second resistor introduces hysteresis so as to set different light illumination thresholds or limits for turning the light source on and off.

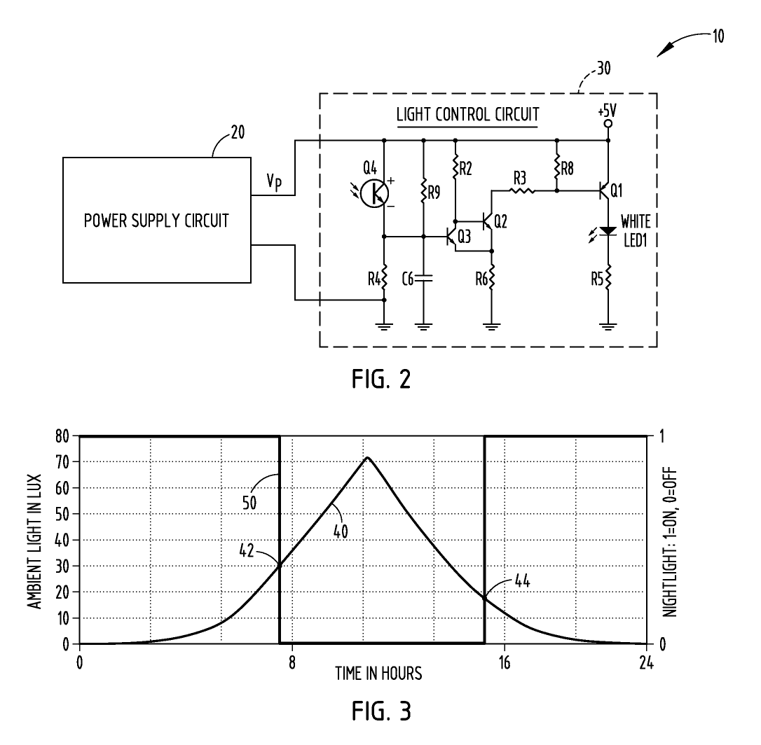

The lighting device 10 is further illustrated in FIG. 2 having power supply circuitry 20 and light control circuitry 30. The power supply circuit 20 may include a conventional power supply for supplying electric power to a lighting device, such as a nightlight. The power supply circuitry may include a power supply input for receiving AC power, such as 110-240 volts AC at 50/60 hertz. The power supply circuit 20 converts the AC voltage input to a DC voltage sufficient to drive the light source, shown as a white light emitting diode (LED) labeled LED1, and to further power the control circuit 30. According to one embodiment, the transformed voltage is converted to a three volt (+3 v) DC voltage V_{P} applied as the input to the light control circuit 30 and light source LED1. The power supply circuit 20 also provides a ground or return connection to the light control circuit 30. It should be appreciated that other DC voltages may be used to power the control circuit 30 and light source LED1.

Light control circuit 30 is shown including the light sensing phototransistor Q4 and the light source LED1. The phototransistor Q4 may include a conventional NPN silicon phototransistor having a collector shown by the positive (+) sign and an emitter shown by the negative (−) sign. The phototransistor Q4 senses ambient light illumination and sources current from the collector to the emitter based on the amount of sensed light illumination.

The control circuitry has a first resistor R4 connected in series with the phototransistor Q4 between the emitter and ground. First resistor R4 sets the on/off photo limit or threshold to turn the light source LED1 on and off. The control circuitry also has a second resistor R9 connected in parallel with the phototransistor Q4. Second resistor R9 is connected in parallel with the phototransistor Q4 across the collector and emitter of the phototransistor Q4 and operates to introduce hysteresis. The second resistor R9 has a resistance value selected to adjust the sensitivity of a sensing base current of a transistor that turns the light source on and off. The base current biases the base of the transistor to turn the light source on and off based on an illumination level defined by the second resistor R9. The second resistor may have a value of less than 10 megaohms according to one embodiment and a value of approximately one megaohm according to a specific embodiment. The second resistor R9 causes a difference in the light illumination on and off thresholds or limits at which the light source LED1 turns on and off, referred to as a light illumination difference. The hysteresis results in the light source turning off at a first light level and turning on at a second light level that is less than the first light level by the light illumination difference. The hysteresis is sufficient to prevent flicker of the light source LED1 during operation of the nightlight 10.

The control circuitry 30 further includes a capacitor C6 connected in parallel with resistor R4 so as to form an RC network which provides a time delay. The time delay may be several milliseconds.

The light control circuitry 30 is further shown having a Darlington pair of transistors Q2 and Q3 coupled to the emitter of phototransistor Q4. A current limiting resistor R6 is connected between the Darlington pair of transistors Q2 and Q3 and ground. Additionally, resistors R2, R3 and R8 are connected between the Darlington pair of transistors Q2 and Q3 and the DC power supply of five volts to bias transistors Q2 and Q3. A transistor Q1 is shown connected to the light source LED1 for turning the light source LED1 on and off. Transistor Q1 has a base coupled to the Darlington pair of transistors Q2 and Q3 and resistors R3 and R8 and operates to turn the light source LED1 on and off based on the voltage provided thereto which is based on the sensed ambient light. A resistor R5 is further connected between the light source LED1 and ground.

In operation, the nightlight 10 operates to turn off the light source LED1 when the ambient light illumination detected by phototransistor Q4 exceeds a first light illumination threshold. When the light illumination sensed by phototransistor Q4 drops below a second lower threshold, the light source LED1 is turned on. Resistor R9 provides hysteresis to ensure that the difference between the first threshold and second threshold is of a sufficient magnitude to prevent flicker of the light source LED1 during normal operation.

An example of sensed light illumination and control of the light source LED1 with the nightlight 10 during a twenty-four (24) hour period is illustrated in FIG. 3. The sensed light illumination measured in units of lux is shown by line 40 rising up while the light source shown by line 50 is initially on, the light source turning off, the illumination dropping, and the light source turning back on. When the second light illumination indicated by line 40 rises and reaches the first threshold at point 42, the light source is turned off due to sufficient sensed ambient lighting. When the sensed light illumination on line 40 drops below a second lower threshold at point 44, the light source is turned back on as shown by line 50. The difference between the first threshold at point 42 and the second threshold at point 44 in the example shown is approximately thirteen (13) lux. According to one embodiment, the light illumination difference may have a minimum value of five (5) lux and is sufficient to eliminate or reduce light flickering. It should be appreciated that the presence of the second resistor R9 connected in parallel with the phototransistor Q4 provides the relatively large light illumination difference between the first and second thresholds so as to provide hysteresis to prevent the light source from undesirably turning on and off such as light flickering.

In FIG. 4, a lighting device 110 is shown as a path light, according to a second embodiment. The path light 110 includes a housing 112, a light illumination portion 114, an ambient light detection sensor 116, an AC power connector 118, and a motion sensor 60. The housing 118 defines a volume that contains power control circuitry, motion sensing circuitry, and light control circuitry. The light output portion 114 includes a light source, such as an LED. The light detector 116 includes a phototransistor for sensing ambient light. The AC power connector 118 serves as a power supply input.

The path light 110 generally operates similar to the nightlight 10 shown in FIG. 1, with the exception that the path light 110 further includes a motion sensor 60 and related circuitry for sensing motion of an object in proximity to the path light 110 and controlling activation of the light source based on the sensed motion and sensed ambient light. The path light 110 activates or turns on the light source when the ambient light sensed by the phototransistor is below a threshold level and motion of an object is detected with the motion sensor 60. If either motion is not detected or the sensed light exceeds a threshold limit, the path light 110 remains turned off Thus, power is only consumed when the environment at or near the path light 110 is sufficiently dark and an object in motion is detected.

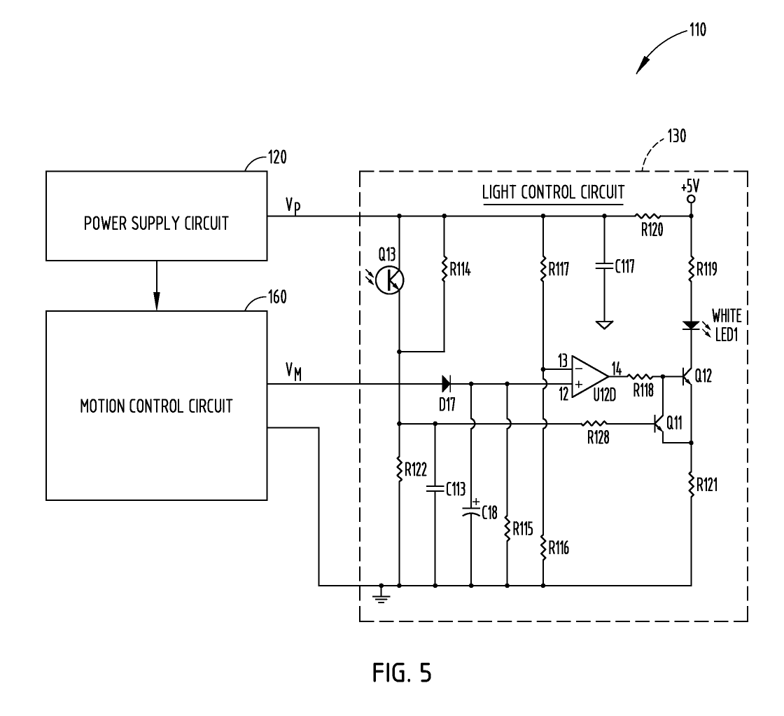

The path light 110 is further illustrated in FIG. 5 having power supply circuit 120, motion control circuit 160 and light control circuit 130 which includes the light source LED1 and a phototransistor Q13. The power supply circuit 120 may include a conventional power supply including circuitry for converting power for an AC power supply to DC power V_{P} of a sufficient voltage magnitude, such as five volts. The motion control circuit 160 may include conventional motion control circuitry associated with a motion detector. The motion sensor may employ any of a number of known techniques for sensing motion including infrared, radar, ultrasonic signals, and other sensing techniques for sensing the presence of an object in motion in close proximity to the sensor. The motion control circuit 160 generates a voltage output V_{M} which is supplied to the light control circuit 130. The motion control circuit is also shown providing a ground connection to the light control circuit 130. The power supply circuit 120 may also provide a ground or return connection to the light control circuit 130.

The light control circuit 130 is shown including a light sensing phototransistor Q13 and a light source shown as white LED1. The phototransistor Q13 may include a conventional phototransistor, such as the type described above in connection with the nightlight shown in FIG. 1. The phototransistor Q13 senses light illumination and sources current from the collector to the emitter based on the amount of sensed light illumination. The control circuitry 130 has a first resistor R122 connected in series with the phototransistor Q13 between the emitter and ground. First resistor R122 sets the photo limit to turn the light source LED1 on and off. The control circuitry 130 also has a second resistor R114 connected in parallel with the phototransistor Q13. Second resistor R114 is connected in parallel with the transistor Q13 across the collector and emitter of the phototransistor Q13 and operates to introduce hysteresis. The second resistor R114 causes a difference in the light illumination thresholds or limits at which the light source LED1 turns on and off. The hysteresis results in the light source LED1 turning off at first light level and turning on at a second light level that is less than the first light level by the light illumination difference. The hysteresis is sufficient to prevent flicker of the light source during operation of the path light.

The control circuitry 130 further includes a capacitor C113 connected in parallel with resistor R122 to form an RC network which provides a time delay, such as several milliseconds. The output voltage of the motion control circuit passes through diode D17 to op amp U12D. Additionally, the capacitor C18 and resistor R115 are coupled between the positive (+) input of op amp U12D and ground. The op amp U12D has a negative (−) input coupled between resistor R117 and R116. Op amp U12D compares the motion control circuit output voltage to the voltage on the negative input and generates an output to resistor R118 which is applied to the base to transistor Q12 and also to the collector of transistor Q11. The light source LED1 is connected in series with resistor R121, transistor Q12 and resistor R119 which receives +5 volts DC. Additionally, capacitor C117 and resistor R120 are connected to the positive voltage supply of five volts.

In operation, the path light 110 operates to turn off the light source LED1 when the light illumination detected by phototransistor Q13 rises above a first illumination threshold or when no motion is detected. When the light illumination sensed by the phototransistor drops below a second lower threshold, and motion of an object is detected with the motion sensor, the light source LED1 is turned on. In doing so, resistor R114 provides hysteresis to ensure that the distance between the first threshold and the second threshold is of a sufficient magnitude to prevent flicker of the light source during normal operation.

The use of a resistor in parallel to the phototransistor advantageously provides hysteresis to provide or reduce flicker of the light source in a lighting device. The lighting device is particularly useful as a nightlight or a path light. However, it should be appreciated that other types of lighting devices may employ the phototransistor and light control circuit according to the embodiments.

The above description is considered that of the preferred embodiment only. Modifications of the invention will occur to those skilled in the art and to those who make or use the invention. Therefore, it is understood that the embodiment shown in the drawings and described above is merely for illustrative purposes and not intended to limit the scope of the invention, which is defined by the following claims as interpreted according to the principles of patent law, including the Doctrine of Equivalents.

The invention claimed is:

1. A lighting device comprising:
a power supply input;
a light source;
a phototransistor for sensing ambient light; and
control circuitry for turning the light source on and off based on the sensed ambient light, said control circuitry comprising a first resistor in series with the phototransistor and a second resistor in parallel with the phototransistor, wherein the first resistor sets an illumination limit to turn the light source on and off and the second resistor introduces hysteresis such that the light source is turned on and off at different illumination limits.

2. The lighting device of claim 1, wherein the second resistor is coupled in parallel across a collector and an emitter of the phototransistor.

3. The lighting device of claim 1, wherein the second resistor has a resistance value selected to adjust the sensitivity of a sensing base current of a transistor that turns the light source on and off.

4. The lighting device of claim 3, wherein the base current biases the base of the transistor to turn the light source on or off based on an illumination level defined by the second resistor.

5. The lighting device of claim 1, wherein the second resistor has a value of less than ten megaohms.

6. The lighting device of claim 1, wherein the second resistor has a value of about one megaohm.

7. The lighting device of claim 1, wherein the lighting device is a nightlight.

8. The lighting device of claim 1, wherein the light is a path light further comprising a motion sensor for sensing motion, wherein the lighting source is turned on when both motion is detected and the sensed light is below the illumination level.

9. The lighting device of claim 1, wherein the light source comprises a light emitting diode (LED).

10. A nightlight comprising:
a power supply input;
a light source;
a phototransistor for sensing ambient light; and
control circuitry for turning the light source on and off based on the sensed ambient light, said control circuitry comprising a first resistor in series with the phototransistor and a second resistor in parallel with the phototransistor, wherein the first resistor sets an illumination limit to the turn the light source on and off and the second resistor introduces hysteresis such that the light source is turned on and off at different illumination limits.

11. The nightlight of claim 10, wherein the second resistor is coupled in parallel across a collector and an emitter of the phototransistor.

12. The nightlight of claim 10, wherein the second resistor has a resistance value selected to adjust a sensitivity of a sensing base current of a transistor that turns the light source on and off.

13. The nightlight of claim 12, wherein the base current senses the base of the transistor to turn the light source on or off based on an illumination level defined by the second resistor.

14. The nightlight of claim 10, wherein the light source comprises a light emitting diode (LED).

15. A path light comprising:
a power supply input;
a light source;
a phototransistor for sensing ambient light;
a motion sensor for sensing motion of an object; and
control circuitry for turning the light source on and off based on the sensed ambient light and the sensed motion, said control circuitry comprising a first resistor in series with the phototransistor and a second resistor in parallel with the phototransistor, wherein the first resistor sets an illumination limit to the turn the light source on and off and the second resistor introduces hysteresis such that the light source is turned on and off at different illumination limits, wherein the lighting source is turned on when both motion is detected and the sensed ambient light is below the illumination level.
